(19) United States
(12) Patent Application Publication
(10) Pub. No.: US 2010/0198621 A1
(43) Pub. Date: Aug. 5, 2010

(54) WORKFLOW-BASED CREATION OF A PATIENT CD

(76) Inventor: Burkhard Schäfer, Pommersfelden (DE)

Correspondence Address: HARNESS, DICKEY & PIERCE, P.L.C., P.O.BOX 8910, RESTON, VA, 20195, US

(21) Appl. No.: 12/696,078

(22) Filed: Jan. 29, 2010

(30) Foreign Application Priority Data
Feb. 2, 2009 (DE) 10 2009 007 075.3

(51) Int. Cl. G06Q 50/00; G06Q 10/00; G06F 17/30

(52) U.S. Cl. 705/3; 707/802; 707/E17.044

(57) ABSTRACT

A method, a mobile data medium and a system are disclosed for transferring medical findings data in configured form as configured data to a client. In at least one embodiment, findings data together with further data is configured here such that it is stored specifically for the respective application on a data medium as configured data. The configured data is created as a function of the analysis of a workflow and/or as a function of metadata relating to a patient examination. The configured data is written to the data medium.

### PRIORITY STATEMENT

The present application hereby claims priority under 35 U.S.C. §119 on German patent application number DE 10 2009 007 075.3 filed Feb. 2, 2009, the entire contents of which are hereby incorporated herein by reference.

### FIELD

At least one embodiment of the invention generally lies within the fields of information technology and medical engineering and generally relates to a method and system for creating a patient and/or referral CD with configured data. In at least one embodiment, the configured data can relate to the patient, to one or more examinations of the patient and/or to at last one specific examination result.

### BACKGROUND

In everyday medical practice there is provision for storing medical data produced in the context of a patient examination on a mobile data medium. This can be done at the request of the patient or to inform the physician carrying out further treatment (e.g. the referral physician).

It is known from the prior art, in the field of radiology in particular, for so-called PACS systems (Picture Archiving and Communication Systems) to allow the production of patient and/or referral CDs. Alternatively other mobile data mediums (e.g. DVDs) can also be produced. These allow the data generated during the course of the radiological examination (e.g. CT, MRT examination, etc.) to be made available to the patient as an additional service. Radiological data can also be made available to the referral physician by way of a mobile data medium. The CD containing the examination data can either be produced directly at the radiologist's workstation or a computer-aided burning device (e.g. a CD burner), which is linked to the radiology system, can be used for this purpose.

One disadvantage of the known systems for creating a mobile data medium is that the information written to the data medium cannot be tailored flexibly and specifically to the respective needs of the user (patient and/or referring physician). This reduces the benefit for the patient and also results in low levels of acceptance on the part of clinical personnel, in particular the referring physician.

### SUMMARY

At least one embodiment of the present invention shows how a user can determine in a flexible manner which data records and which further information are to be written to the mobile data medium together with the findings data.

At least one embodiment of the present invention relates to a method, system and/or computer program product.

Features, advantages or alternative embodiments mentioned in this process can also be applied to the other claimed subject matter and vice versa. In other words the claims (directed for example toward a system or product) can also be developed with the features described or claimed in relation to the method. The corresponding functional features of the method are hereby configured by corresponding objective modules, in particular by hardware modules.

At least one embodiment is directed to a method for executing configurable write access to a mobile data medium containing configured medical data, it being possible for the data also to comprise findings data from at least one examination of a patient. In at least one embodiment, the method comprises:
capturing a workflow relating to the examination and/or
capturing metadata relating to the examination;
analyzing the workflow and/or the metadata;
supplying the findings data;

configuring the data, which may (but does not necessarily have to) include findings data, for write access to the mobile data medium as a function of the analysis of the workflow and/or as a function of the analysis of the metadata;
executing write access to the mobile data medium with the configured data.

The concepts used in the context of embodiments of the invention are explained in greater detail below.

The data medium is in particular a mobile data medium, for example a CD, DVD or other mobile data medium in another format. Alternatively portable hard drives, memory sticks or the like can also be used here.

In an example embodiment the findings data originates from a radiological examination, e.g. a CT examination, MRT examination, ultrasound examination or other examinations using imaging methods. In alternative embodiments, the present invention can also be applied to all further medical examinations (e.g. laboratory tests, examinations by a general practitioner in respect of the general state of the patient). The term “findings data” then relates to all data records that may be relevant to at least one patient. According to at least one embodiment of the invention there may be cases where the configured data does not comprise any, findings data but only background information for example. It is also possible for the configured data only to comprise some of the findings data, in other words for example only the image data from an imaging examination (e.g. MRT, CT, etc.) and optionally a mini viewer for viewing said image data, without a further physician's report.

The term “write access” is understood to mean that data is written to the data medium. If the data medium is a CD or DVD, a burner robot is used to burn configured data onto the CD/DVD.

“Configurable or configured” in this context means that the write access does not store the data to the mobile data medium according to a predefined, fixed pattern but the user or someone else (e.g. the person creating the data) can set how and in which form the data is to be stored on the data medium. “Configured data” can therefore in principle be all data records which are relevant in respect of at least one patient. The configured data can comprise all or a selection of findings data. It can be stored on the data medium with or without a viewer. It can be stored in a specified form (format, degree of compression, encryption, etc.). For example the user can specify a selection of the findings and/or examination data. Further additional information can also be supplied, being generated as a function of the workflow in respect of the patient examination and/or as a function of further metadata in respect of the patient examination. It is thus possible to write specific examination data and/or findings data, which is relevant to the respective case, specifically to the data medium. “Configurable” in this context relates to the type of data to be stored, the relevance and/or sorting of the data to be stored, the size of the data to be stored, the format of the data to be stored, display modalities, the selection of findings data and additional data or further parameters relating to the findings data and/or in respect of the data to be stored.

The term “workflow” in this context means the medical sequence of steps, which are executed in the context of the patient examination. It includes for example the admission of the patient to a clinic, the performance of a patient examination, the collection of statistical values in the context of the patient examination, access to metainformation, etc.

The workflow can be internal to the clinic and cross-clinic, so that external medical practices for example can also be integrated in the workflow.

Metadata relating to the examination comprises all data captured in the context of the examination. This includes for example the type of examination device, the time of the examination, information in the so-called DICOM header, data relating to the persons performing the examination (physician, MTA, etc.), radiation exposure data, threshold values and comparison values, patient information, information about the clinic or medical practice or relating to the treating physician, appointment data, etc.

One significant advantage of an inventive solution of at least one embodiment can be seen as being that by taking into account the workflow or taking into account metadata, only relevant information is stored on the CD. For example different, and generally much more, detailed medical information is stored on the data medium, if the mobile data medium is designed for a referring physician, who is scheduling an operation for example, than when the mobile data medium is intended for the patient or the medical insurance company. If the medical workflow comprises even more steps, which have to be executed in respect of the patient, the data to be stored on the data medium will be more detailed and will provide all possible accompanying information of relevance for the planned workflow steps. This specific and dedicated configuration of the data to be stored has significant performance benefits, as all the relevant information can be automatically made available on the data medium, without any manual steps being required on the part of the user. In contrast to former systems from the prior art it is not necessary in particular for the user to compile the data records from different data sources. The data to be stored is preferably compiled automatically. The sources, which are in principle available for data, can be set in a variable manner according to one preferred embodiment of the invention. Particular reference should be made here to the DICOM data record, including the DICOM header, a DICOM modality worklist, all or selected steps of a so-called modality-performed procedure step, data records from the DIS/RIS or other linked information systems (e.g. hospital information system KIS, etc.).

According to one example embodiment, the configured data to be stored comprises further additional information in addition to the findings data. The additional information is data records relating to the examination of the patient or relating to the patient, relating to the clinic or medical practice, relating to the workflow or relating to further medical aspects. Generally therefore further additional information is stored on the data medium in addition to the findings data. It is however also possible for just the findings data to be stored on the data medium in specific application scenarios. This can be expedient for example if additional information is already available via other routes or through earlier examinations. Here too the findings data can be tailored in a specific manner. It is also possible here to determine and/or configure the data format, a specific data selection, the manner of compression and further parameters relating to the findings data on a case by case basis.

The additional information can originate from different data sources or databases and is selected specifically for the respective application. The additional information is preferably selected and/or configured as a function of the workflow analysis. Alternatively or cumulatively it is possible to select and/or configure the additional information as a function of the analysis of the metadata. It is also possible for a user here to actuate manual inputs by way of a corresponding user interface to determine certain additional information in a specific manner.

For example a user here can specify that accompanying information about the treating physician (e.g. CV, qualifications, etc.) and/or background information about the illness of the respective patient is also to be stored along with the findings data on “his/her” data medium. The user can also belong to the area of the radiology department in which the examination data is captured. So for example the radiologist can determine which additional information is also to be stored on the data medium, as he/she has also examined the patient and knows which medical data is important and which not.

Generally the additional information is image data (two-dimensional, three-dimensional or four-dimensional image data), data in an acoustic format and/or text data, which can serve for example as accompanying or background information or a combination of these or other formats. It is also possible for the additional information to be made available in a different format. For example the additional information can also comprise executable programs. It is thus possible for the additional information to include programs for displaying the findings data and/or for further processing the findings data. These include for example compression programs, storage programs and post-processing programs.

According to one advantageous development of at least one embodiment of the invention provision is made for the method to include an additional method step. This method step is designed to capture at least one patient and/or referring physician-related requirement profile. The patient and/or referring physician-related requirement profile is specific storage parameters or requirements which either the patient and/or the referring physician or the recipient of the data medium sets for the data to be stored on the data medium. As mentioned above, it is possible here for the recipient to set specific personal or situation-related settings to personalize the CD content for his/her application context. The data is then configured for write access as a function of the captured recipient-related requirement profile. In principle a number of recipients can also be provided for a data medium.

According to one further embodiment of the invention the additional information also includes data from other data sources. As well as anatomical information this also includes standard values for measured values (e.g. laboratory values) or standard values for displaying specific organs, comparison and/or threshold values for the examination performed, device information relating to the device used to perform the examination. The additional information can also comprise further metainformation.

In one example embodiment the present invention is employed in the area of radiology and for a radiological examination. Alternatively the method can however also be employed at any time for laboratory tests or other examinations.

The data medium generally has different recipient types. On the one hand a patient CD is provided so the recipient type is a patient; on the other hand a referral CD can be generated, so the recipient type is a treating physician or a referring physician. Alternatively other recipient types can also be defined, for example a medical insurance company, clinical research facilities, which carry out clinical studies based on the captured data records. Further statistical processing may also be scheduled.

At least one embodiment is further directed to a mobile data medium, which has been written using a method described above in relation to the method-related solution.

At least one embodiment is further directed to a system for transferring configured data, comprising:
a device (e.g. modality) for providing medical findings data; generally this is a radiological system, e.g. a PACS system;
a mobile data medium for storing configured data, it being possible for the configured data to comprise findings data along with additional information, it being stored in a predeterminable form and
a writer to write the mobile data medium according to at least one embodiment of a method as described above.

The method is generally a computer-implemented method, which can itself be stored on a mobile data medium and can also be executed on a computer, when the program is loaded on the computer.

The inventive embodiments of the method described above can also be configured as computer program product, the computer being prompted to implement the inventive method described above, when the program is executed on the computer or a processor of the computer.

In one alternative solution a storage medium is provided, which is intended for storing the computer-implemented method described above and can be read by a computer.

It is also possible for individual components of the system described above to be executed in a marketable unit and for the remaining components to be executed in another marketable unit—as a distributed system so to speak. In other words the writer can also be part of the PACS system or an external module connected by way of a network. In another embodiment the writer can also be sited on the recipient's premises, therefore being part of the recipient system. This can be expedient for example when the configured data has already been transferred to the recipient anyway (by another route) and is only to be provided there in configured form.

### BRIEF DESCRIPTION OF THE DRAWINGS

In the detailed description of the figures below example embodiments, which are not to be understood as restricting, along with their features and further advantages are discussed with reference to the drawing, in which:

FIG. 1 shows an overview-type schematic diagram of an inventive system according to an example embodiment and

FIG. 2 shows a flow diagram according to an example embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

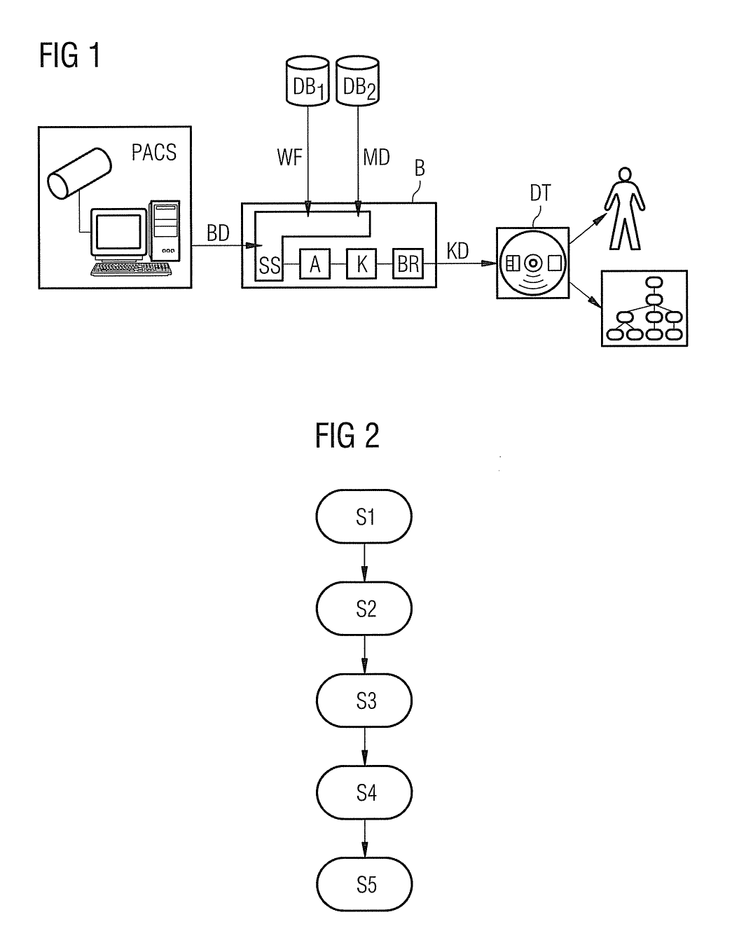

An example embodiment of the present invention is described below with reference to FIG. 1.

The left side of FIG. 1 shows an imaging unit of a clinical system. This can be a PACS system or other imaging modalities, laboratory devices or further examination devices for examining a patient. FIG. 1 shows a PACS system by way of example, which provides medical findings data BD. In alternative embodiments a number of devices can be connected together here by way of a network. These can be devices of a clinical facility or devices, which are used in the context of a medical practice or laboratory.

The findings data BD relates to at least one examination of a patient. The findings data BD can however also relate to a number of examinations of a patient, which are combined. The findings data BD is fed to a writer B. The writer B is a computer-aided burner robot, which comprises an interface for reading in the findings data BD and for reading in workflow data WF and/or metadata MD and for writing to a mobile data medium DT. The mobile data medium DT is shown schematically on the right side of FIG. 1.

In one example embodiment the data medium DT is a CD or DVD, which is intended either for a patient, for a medical insurance company or for referring physicians. The content of the data medium DT is generally different if it is intended for the patient or for a referring physician. The arrows from the data medium DT pointing obliquely up to the right and obliquely down to the right in FIG. 1 show that they are intended for different recipients. The arrow pointing upward is to indicate a patient CD, while the downward pointing arrow is intended to represent a referral CD. In alternative embodiments the content of the data medium DT can also be intended for further applications and/or customer groups. Possibilities here include units which carry out statistical evaluations of findings data BD or administrative units or further research institutions, etc.

As shown in FIG. 1, further data is fed to the writer B in addition to the findings data BD. This is data relating to a workflow WF in the context of the patient examination and metadata MD in the context of the patient examination. In alternative embodiments further data can also be routed to the writer B. The workflow data WF and metadata MD can be stored in the same database DB or in different databases DB, as shown in FIG. 1.

The writer B is a computer-aided device and can also be configured as a burner robot. It can comprise a number of modules, which can be partially implemented in software and/or in hardware.

In one example embodiment the writer B comprises an interface SS for reading in data. The findings data BD, workflow data WF and die metadata MD is preferably provided here. The writer B further comprises an analysis module A, a configuration module K and a burner BR.

All the modules of the writer B exchange data with one another. The analysis module A serves to analyze the workflow data WF and/or to analyze the metadata MD. In more complex embodiments further data relating to the patient examination or more comprehensive data can be fed to the writer B and is also analyzed in the analysis module A.

The result of the analysis by the analysis modules A is then fed to the configuration module K. The configuration module K serves to configure the data, which is then to be stored on the mobile data medium DT, in particular as a function of the result of the preceding analysis. The configuration module K serves to generate configuration data KD (also referred to below as configured data KD).

The configuration data KD relates to the findings data BD and can also comprise additional information. It can be specified on the basis of the interpretation of the analysis module A whether all the findings data BD or just a selection is to be stored. Provision can also be made for further findings data, e.g. from earlier or other examinations of the same patient, to be taken into account and stored in addition to the findings data BD.

It is also possible to specify the form or format in which the data is to be stored. The burner BR serves to burn the configured data KD on the mobile data medium DT. In one preferred embodiment this can be a conventional burner BR for writing CDs, DVDs or the like.

One important advantage of the inventive solution of at least one embodiment can be seen as being that the configured data KD is stored on the data medium DT specifically for the respective application. The criteria according to which the configuration module K determines the configuration data KD can thus be specified. It can for example be specified here that all the metadata MD is to be supplied on the data medium DT in addition to the findings data BD. Otherwise just a selection of data can be stored on the data medium DT as a function of the workflow WF in relation to the respective patient examination. Other basic conditions for storing the configuration data KD can also be taken into account for the configuration module K, e.g. degree of compression for the configuration data KD, format to be stored, in which the configuration data KD is saved or a directory, in which the configured data KD is saved, etc.

Depending on the embodiment, the writer B can be integrated in different positions within the overall system. On the one hand it is possible for the writer B to be integrated directly at a workstation of a medical device for generating findings data BD. For example the writer B can be linked directly to the workstation of a radiologist or an MTA or can be integrated directly therein. It is also possible for the writer B to be provided as a separate unit, which is linked by way of a network connection to a medical facility (e.g. PACS systems, etc.). It is also possible to configure the writer B as a software module, which is linked to a commercially available CD writer. It is thus possible to extend an already commercially available burner robot according to the invention, by providing a software and/or hardware module—as an add-on so to speak—which executes all or selected method steps of the method described above. The module is intended in particular to execute write access with the configured data. All further steps of the method can be executed by the module or writer B directly or even by means of linked entities (linked by way of a network).

In a further embodiment provision is made for the writer B, as well as writing the configured data KD to the data medium DT, to create a label, showing the configured data KD, which can then be attached to the data medium DT to identify it.

If it is a patient CD, it can be created so that it is tailored specifically to the needs of the patient. For example it is not necessary for a patient CD to comprise information about the patient, as the patient generally has this information themselves. However information identifying the recipient (in particular therefore the patient) is generally always included, to ensure that any subsequent confusion is reliably avoided. In one preferred embodiment it is also possible to specify which information qualifies as identifying. It is however frequency extremely expedient for the patient to receive background information about the examination carried out and/or for example about further planned examinations in the context of the workflow WF.

If it is a referral CD, the configured data KD is generally tailored specifically to the requirements of the referring physicians. An orthopedist for example generally requires different configured data KD from a physician having to schedule a further operation on the patient. The referral CD can either be given to the patient or it can be sent directly to the referring physician.

In one alternative embodiment a physical data medium DT is not produced but the configured data KD is sent as a data packet by way of a network to a specified recipient address. The recipient address can for example be an internet address of the patient and/or of referring physicians. The data packet is generally sent encrypted, to prevent data abuse and can be called up as a packet by the recipient. The data packet is configured specifically for the application according to an embodiment of the inventive method.

In the example embodiment the image data of the findings data BD is available in DICOM format (Digital Imaging and Communications in Medicine). To improve interoperability it is also possible to store all or a segment of the configured data KD on the data medium DT in DICOM format. The configured data KD can also be stored in different formats on the data medium DT, if the user wishes. The user can specify suitable settings for data configuration before the write access. Generally a corresponding screen interface is provided for this purpose to select or input configuration parameters. Such a configuration parameter then relates for example to the desired storage format(s).

Generally further medical standards are also taken into account for data configuration. IHE (Integrating the Healthcare Enterprise) requirements for example or DRG conditions can be taken into account in this process.

Depending on the underlying workflow WF data from different data sources is used to determine the content of the data medium DT. The following sources are possible data sources:
A DICOM header of the image data (e.g. study description). A number of different headers can of course also be taken into account here.
If a DICOM modality worklist is made available by the DIS or RIS (Radiology Information System), the data from this worklist can be used. This also applies even if the image data from this worklist is not to be stored on the data medium DT.
If it is known for example from the workflow WF that for one type of examination the findings are produced immediately, the burning of the data medium DT can wait until the findings of the patient examination are also available, to write the findings to the data medium DT as well.
So-called modality-performed procedure steps can be used for example to determine the total radiation dose administered; this information can be processed and stored together with doses from preliminary examinations on the data medium DT. Statutory threshold values or risk assessments and a comparison of the radiation doses with these threshold values or risk assessments can also be stored on the data medium DT.
If a medical report is available, data from this report can also be read and used for the configured data KD. It is also possible just to use a selection of the, report data as additional information for the configured data KD. Either DICOM tags from the structured report can be used for this purpose or a search can be carried out for text modules in the finished report.
If data of the DIS/RIS (Radiology Information System) is also taken into account, this can be compared with workflow data WF and/or with statistical values and processed for the respective patient. It is possible here to generate and display a waiting period until the appointment, a waiting period from arrival to writing of the data medium DT.

One important advantage of an embodiment of the inventive solution can be seen as being that the recipient of the data medium DT receives all the information of relevance to him/her automatically prepared in the desired form. He/she does not first have to search manually for the information of interest from different data sources. He/she is also able to specify certain conditions for the production of the configured data KD (e.g. format, selection, display conditions, etc.) at the start. The content of the data medium DT can thus be tailored in a certain specific manner to the respective recipient.

If findings are available, it is possible to generate a website containing patient information as configured data as a function of a so-called admitting diagnosis and/or as a function of the findings text, for example as additional information. The patient can thus be provided with substantiated information about his/her illness and therapy options. It is possible to derive the examined part of the body for example from the DICOM header of the image data. Anatomical information can also be written as configured data KD to the CD as additional information from a further data source. The configured data KD can comprise for example a video of organ function. A modality-performed procedure step can also be used to derive the criterion for the level of the radiological dose during the patient examination.

An overview of radiation exposure, threshold values and comparison values can be provided as background information for the patient as additional information in the form of the configured data KD. The DICOM header of the image data can be used to capture the examined part of the body (e.g. head, full body scan, etc.). The configured data can comprise a three-dimensional CAD display of the examined part of the body as additional information.

In addition to the actual findings data BD the configured data KD can also comprise further additional information, which relates for example to device information, in other words to the device used to carry out the patient examination or information about the practice of the referring physician or about the treating physician, waiting period statistics or statistics relating to the patient examination, image viewing software is provided as a function of the patient examination. If local statutory requirements are met, it is also possible to include and play advertising information. The advertising information can relate for example to the device manufacturer or a therapeutic agent for treating the patient's illness, which can be derived from the inventively captured data (e.g. from the metadata or findings data).

Generally the configured data KD is a combination of image data and text data. Alternatively or cumulatively it can also comprise executable programs, e.g. specific further processing software or further software for displaying or further processing the findings data BD.

As shown in FIG. 1 in addition to the findings data BD further data relating to the patient examination is also fed to writer B, such as workflow data WF and metadata MD. Further parameters in respect of the patient examination can also be taken into account and fed to the writer. For, example specific requirement profiles can also be taken into account as a function of the specifications of the referring physician (attribute “referring physician”) or as agreed with the referring physician and be fed to the writer for the purposes of configuring the data. The referring physician can specify for example whether practice information of the referring physician is also to be burned onto the data medium DT, whether certain image viewing software is also to be stored on the data medium DT, whether the images are to be stored compressed and if so, with what degree of compression or using what compression software, whether all findings-related images are to be stored on the data medium DT or just a selection and if just a selection is to be stored, the referring physician can determine the criteria according to which the selection of findings data BD for storage on the data medium DT is to be made.

A typical sequence according to an example embodiment of the inventive method is described below in conjunction with FIG. 2. It should be noted here that a different sequence of method steps can also be executed. It is possible in particular to interchange the first and second steps.

In a first step S1 findings data BD is read in by the writer B.

In a second step S2 workflow-related data WF and/or metadata MD or further additional information is read in by the writer B.

In a third step S3 all the read in data is analyzed. The analysis follows preconfigurable parameters. Selection criteria can be specified for example or the data to be taken into account generally for the analysis.

In a fourth step S4 the data is configured for write access to the data medium DT. The configured data KD is thus generated and compiled here.

In a last, fifth step S5 write access with the configured data KD to the data medium DT is executed.

In a less complex embodiment of the invention it is also possible for fewer input parameters to be taken into account as configuration parameters for the configured data KD. Workflow-related data WF and the metadata MD, as well as the findings data BD itself or configuration parameters derived from the findings data generally serves as configuration parameters. It is now also possible just to define a selection of configuration parameters and take into account for example just the workflow-relates data WF or just the findings data BD itself or configuration parameters derived from the findings data.

The analysis is preferably carried out completely automatically by the analysis module A. A set of rules is preferably used here, which includes rules for determining configured data KD. For example rules can be stored, such as:

“If ‘Referring Physician is xyz’ and ‘Viewer is required: +’-->Add executable file for viewer to the configured data KD”.

It is also possible to provide for a semi-automatic analysis, so that certain user inputs are requested, from which it is then possible to derive configuration parameters.

Finally it should be noted that the description of the invention and the example embodiments are not to be understood in principle as restricting in respect of a certain physical realization of the invention. It is particularly evident to a person skilled in the pertinent art that the invention can be realized in such manner that it is distributed partially or wholly as software and/or hardware and/or over a number of physical products—in particular including computer program products.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

BD Findings data
WF Workflow data
MD Metadata
DB Database
B Writer
SS Interface
A Analysis module
K Configuration module
BR Burner
KD Configured data
DT Data medium
S1 Reading in of findings data
S2 Reading in of workflow data and/or metadata
S3 Analysis of read in data
S4 Configuration of data for write access
S5 Execution of write access with configured data on data medium

What is claimed is:

1. A method for executing a write access to a data medium with configured data relating to at least one medical examination of a patient, comprising:
capturing a workflow relating to the examination;
capturing metadata relating to the examination;
analyzing at least one of the workflow and the metadata;
capturing findings data;
configuring the captured data for write access to the mobile data medium as a function of the analysis of at least one of the workflow and the metadata; and
executing write access to the mobile data medium with the configured data.

2. The method as claimed in claim 1, wherein the configured data comprises findings data and additional information.

3. The method as claimed in claim 2, wherein the additional information is selected or configured as at least one of a function of the analysis of the workflow and a function of the analysis of the metadata.

4. The method as claimed in claim 2, wherein the additional information comprises executable programs.

5. The method as claimed in claim 1, further comprising:
capturing further data comprising at least one of at least one patient and referring physician-related requirement profile, the data for the write access being configured as a function of the captured at least one of at least one patient and referring physician-related requirement profile.

6. The method as claimed in claim 1, wherein the examination is a radiological examination.

7. The method as claimed in claim 1, wherein the data medium is a CD or DVD or other portable data medium.

8. The method as claimed in claim 1, wherein the data medium is intended for at least one of the patient, a referring physician, a medical insurance company and other entities.

9. A mobile data medium, written using the method as claimed in claim 1.

10. A system for transferring configured data relating to a medical examination of a patient, comprising:
a PACS system, to provide findings data;
a mobile data medium to store the configured data in configured form, the configured data comprising all or part of the findings data and additional information; and
a writer to configure writing of configured data to the mobile data medium according to at least
capturing a workflow relating to the examination,
capturing metadata relating to the examination,
analyzing at least one of the workflow and the metadata,
capturing findings data,
configuring the captured data for write access to the mobile data medium as a function of the analysis of at least one of the workflow and the metadata, and
executing write access to the mobile data medium with the configured data.

11. The method as claimed in claim 2, wherein the executable programs are programs for at least one of displaying the findings data and for further processing the findings data.

12. The method as claimed in claim 3, wherein the additional information comprises executable programs.

13. The method as claimed in claim 12, wherein the executable programs are programs for at least one of displaying the findings data and for further processing the findings data.

14. A computer readable medium including program segments for, when executed on a computer device, causing the computer device to implement the method of claim 1.
